(19) United States
(12) Patent Application Publication
(10) Pub. No.: US 2013/0236796 A1
(43) Pub. Date: Sep. 12, 2013

(54) LITHIUM BATTERY

(71) Applicants: Youngsik Kim, Fishers, IN (US); Rongrong Chen, Fishers, IN (US); Hui He, Fishers, IN (US)

(72) Inventors: Youngsik Kim, Fishers, IN (US); Rongrong Chen, Fishers, IN (US); Hui He, Fishers, IN (US)

(21) Appl. No.: 13/605,700

(22) Filed: Sep. 6, 2012

Related U.S. Application Data
(60) Provisional application No. 61/531,342, filed on Sep. 6, 2011.
(60) Provisional application No. 61/531,330, filed on Sep. 6, 2011.
(60) Provisional application No. 61/531,822, filed on Sep. 7, 2011.

(51) Int. Cl. H01M 12/08

(52) U.S. Cl. CPC H01M 12/08
USPC 429/405; 429/535

(57) ABSTRACT

An electrochemical cell, including a first electrode, a second electrode spaced from the first electrode, and a lithium ion electrolyte disposed between the first and second electrode and in ionic communication therewith. The first electrode is selected from the group including LiVS₂, Li_{0.8}VS₂, LiV₂O₅ intercalated with sulfur, LiV₆O₁₅ intercalated with sulfur, and combinations thereof.

### CROSS-REFERENCE TO RELATED APPLICATIONS

This application claims priority to co-pending U.S. Provisional Patent Application Ser. No. 61/531,342 and 61/531,330, both filed on Sep. 6, 2011, and co-pending U.S. Provisional Patent Application Ser. No. 61/531,822, filed on Sep. 7, 2011, and incorporates the same herein in their respective entireties.

### TECHNICAL FIELD

The novel technology relates generally to electrochemistry, and, more particularly, to a lithium anode battery system.

### BACKGROUND

Another problem facing known lithium ion batteries is that there is yet to be found a cathode material that can match the graphite anode for specific capacity, cost-effectiveness, and greenness. There are different categories of cathode materials, popular among them being layered compounds such as LiTiS₂, LiCoO₂, LiNi₁₋ₓCoₓO₂, and LiNiₓMnₓCo₁₋₂ₓO₂. Another group of cathode materials with more open structures, such as vanadium oxides, tunnel compounds of manganese oxides, and transition metal phosphates (e.g., the olivine LiFePO₄) has also received attention from researchers. This group of materials generally provides better safety and lower cost.

Vanadium layered oxides such as LiₓV₂O₅, LiₓV₃O₈, and LiₓV₆O₁₃ have attracted a lot of attention as a typical intercalation compound because it is cheap, easy to synthesize and contributes high energy density. One lithium atom per formula unit can be reversibly intercalated into vanadium layered oxides, which give the specific capacity, ˜300 mAh/g. However, vanadium oxides are very sensitive to over discharge: a lithium content of x=1 in LiₓV₂O₅ with several distinct steps cannot be exceeded without losing the reversibility of the insertion process.

Many studies have been conducted to improve the lithium intercalation reversibility and electrical conductivity performance by synthesizing the vanadium oxides with a more open crystal structure or by incorporating highly conductive materials into the structures. The modification of the fabrication method, morphology, and crystallites of vanadium oxides also have been attempted to improve the electrochemical performances. γLiV₃O₈ nanorods obtained at 160° C. shows a larger capacity of 259 mAh/g in the range of 1.5-4.2 V and its capacity remains 199 mAh/g after 20 cycles. LiV₃O₈ nanorod treated at 300° C. has a capacity of 302 mAh/g in the range of 1.8-4 V and its capacity remains at 278 mAh/g after 30 cycles. Although the cycle life performance is improved in modified or nanosized vanadium oxides, it is still not acceptable for commercial battery applications.

Recently, aqueous Li-air batteries have attracted a lot of attention due to their high theoretical energy capacity. However, still in their very early stages of research, the reported performance of Li-air batteries is far from what has been predicted theoretically. Commercial lithium ion (Li-ion) rechargeable batteries using Li intercalation compounds as electrodes are well known. Li-ion batteries can be found in many portable electronic devices, such as cellular phones and laptop computers. Although the Li-ion rechargeable battery has a lot of advantages, such as high gravimetric energy density (120-150 Wh/kg⁻¹), relatively short charging time, and long cycle life, Li-ion battery energy density is still limited by the use of Li intercalation compounds as negative and positive electrodes. By replacing the positive electrode with an air (or O₂) electrode and the negative electrode with a Li metal, the theoretical energy capacity of the Li-air battery is expected to increase to 5000-11000 Wh/kg, depending on two features: the nature of the electrolyte and its reaction products.

Based on these two features, Li-air batteries can be divided into two groups:

(a) Li/02 in non-aqueous electrolytes
Li+O₂=Li₂O₂ (peroxide) E=3.10V
4Li+O₂=2Li₂O E=2.91V

(b) Li/O₂ in aqueous electrolytes

Basic electrolyte: 4Li+O₂+2H₂O=4LiOH E=3.45V

Acidic electrolyte: 4Li+O₂+4H⁺=2H₂O+4Li⁺ E=4.27V

Seawater (pH 8.2): 4Li+O₂+2H₂O=4LiOH E=3.79V

In theory, Li-air batteries with non-aqueous electrolytes can deliver a specific energy density up to 11249 Whr/kg. The first Li-air battery in a non-aqueous electrolyte solution with a structure of Li|organic liquid electrolyte| air electrode was reported in 1996. Gravimetric capacities of about 1600 mAh/g in atmospheric air and 1410 mAh/g in a pure oxygen atmosphere were achieved based on a carbon mass of 20 wt. %. When the mass of carbon increased to 40 wt. %, the capacity decreased due to poor O₂ diffusion through the dense carbon film. Cathode capacity as high as 2825 mAh/g at 0.05 mA/cm² has been observed by modifying the structure of the air electrode to achieve better oxygen diffusion. The highest capacity for a Li-air battery in non-aqueous electrolytes was reported to be as high as 5360 mAh/g (discharged at 0.01 mA/cm²). However, the presence of moisture in the air stream may ultimately lead to the entry of water into the non-aqueous electrolyte and result in life-limiting Li corrosion. Dry air or oxygen has been used instead of atmospheric air in the cathodes in order to minimize the effects of Li corrosion, but this is not a cost-effective solution. Another main challenge for the Li-air battery with a non-aqueous electrolyte is that the discharge products Li₂O₂ and Li₂O are not soluble in an organic liquid electrolyte, and the clogging of porous air electrodes occurred gradually.

Thus, there is a need for an improved lithium battery. The present novel technology addresses this need.

### SUMMARY

The present novel Li-air battery technology exhibits improved discharge and charge voltage efficiency. The novel Li-air battery has a structure of Li|organic liquid electrolyte| Li⁺-conducting glass ceramic plate|water or neutral solution| Pt or carbon air electrode. To minimize the instability effects of the Li⁺-conducting glass ceramic plate in an acid or base solution, pure de-ionized (DI) water may be used as the electrolyte for the air electrode. For the Li-air battery with Pt as air electrode, the observed open circuit voltage was around 3.75V. In water, a discharge voltage plateau of around 3.53V (vs. Li⁺/Li) was observed at the discharge current of 0.05 mA/cm² or 100 mA/g_{carbon}. The charge voltage of the novel Li-air battery is typically in the range of 4.00V to 4.38V (with an average charge voltage of 4.19V) at a current density of 0.05 mA/cm². The novel Li-air battery typically exhibits a high discharge-charge voltage efficiency (84% in pure DI water). The pH of the liquid electrolyte increased during battery discharge by producing LiOH in the water. In LiClO₄ solution, the discharge voltage plateau decreases, but the charge performance improves and the discharge-charge voltage efficiency is typically about 85% in 1M LiClO₄. Further, the pH of the system decreases as compared to the changes of pH in the water system. For carbon as air electrode in the water, the discharge voltage is typically about 3.05V (vs. Li⁺/Li) at the rate of 0.05 mA/cm², 100 mA/g_{carbon}, which is higher than the discharge voltage of a standard the Li-air battery with carbon as catalyst of the air electrode, while the charge voltage of the novel battery was in the range of 4.00V to 4.84V (with an average of 4.42V) at the rate of 0.05 mA/cm². A high discharge-charge efficiency of 69.0% has been observed, higher than that of a standard Li-air battery with a carbon catalyst air electrode. When a LiNO₃ solution replaced pure DI water, the charge performance improved and the fluctuations in pH decreased as compared to that in the water.

### DESCRIPTION OF THE DRAWINGS

FIG. 1 is a schematic diagram of a laboratory-sized aqueous Lithium-air.

FIG. 2A graphically illustrates the discharge and charge performance of developed lithium-air battery with electrically conductive as air electrode at 0.05 mA/cm² (100 mA/g_{carbon}) current density impedance in pure DI water.

FIG. 2B graphically illustrates the discharge and charge performance of developed lithium-air battery with electrically conductive as air electrode at 0.05 mA/cm² (100 mA/g_{carbon}).

FIG. 3A graphically illustrates the discharge and charge impedance curves of developed lithium-air battery at 0.05 mA/cm2 (100 mA/gcarbon) current density in aqueous electrolyte solutions of pure DI water, 0.01M LiOH and 0.01M LiNO3.

FIG. 3B graphically illustrates the discharge and charge voltage curves of developed lithium-air battery at 0.05 mA/cm2 (100 mA/gcarbon) current density in aqueous electrolyte solutions of pure DI water, 0.01M LiOH and 0.01M LiNO3.

FIG. 4A graphically illustrates the discharge and charge curves of developed lithium-air battery with electrically conductive carbon as the air electrode at 0.05 mA/cm2 (100 mA/gcarbon) current density in different solutions.

FIG. 4B graphically illustrates the impedance curves of developed lithium-air battery with electrically conductive carbon as the air electrode at 0.05 mA/cm2 (100 mA/gcarbon) current density in different solutions.

FIG. 5A graphically illustrates the discharge curves at different current densities of the developed lithium-air battery with electrically conductive carbon as the air electrode at different current densities as function of time in pure DI water.

FIG. 5B graphically illustrates the discharge curves at different current densities of the developed lithium-air battery with electrically conductive carbon as the air electrode at different current densities as function of time in 0.01M LiNO3.

FIG. 5C graphically illustrates the discharge curves at different current densities of the developed lithium-air battery with electrically conductive carbon as the air electrode at different current densities as function of time in, (c) discharge curves at different current densities as function of time in 1M LiNO3.

FIG. 5D graphically illustrates the changes of discharge voltage as function of current densities.

FIG. 6A graphically illustrates the electrochemical characterization of changes of inter resistances as function of current densities of the developed lithium-air battery with electrically conductive carbon as air electrode.

FIG. 6B graphically illustrates the electrochemical characterization of changes of pH as function of current densities of the developed lithium-air battery with electrically conductive carbon as air electrode.

FIG. 7A graphically illustrates the discharge and charge performance of developed lithium-air battery with Pt/C as air electrode at 0.05 mA/cm² (100 mA/g_{carbon}) current density.

FIG. 7B graphically illustrates the discharge and charge performance of developed lithium-air battery with a water electrolyte, 0.01M LiOH, and 0.05M LiOH aqueous solutions at 0.05 mA/cm²

FIG. 7C graphically illustrates the initial charge curve of the pure water compared with that of water discharged for 10 h at 0.05 mA/cm².

FIG. 8A graphically illustrates the impedance curves of developed lithium-air battery with Pt/C as air electrode at 0.05 mA/cm² (100 mA/gcarbon) current density in pure DI water and LiClO4.

FIG. 8B graphically illustrates the charge and discharge curve in pure DI water and LiClO4 at 0.05 mA/cm² (100 mA/gcarbon) current density.

FIG. 9A graphically illustrates the discharge curves at different current densities as a function of time in pure DI water for the lithium-air battery with Pt/C as air electrode.

FIG. 9B graphically illustrates the discharge curves at different current densities as function of time in 1.00M LiClO4 for the lithium-air battery with Pt/C as air electrode.

FIG. 9C graphically illustrates the changes of discharge voltage as function of current densities for the lithium-air battery with Pt/C as air electrode.

FIG. 10A graphically illustrates the electrochemical characterization of the changes of inter resistances as function of current densities for the lithium-air battery with Pt/C as air electrode.

FIG. 10B graphically illustrates the electrochemical characterization of the changes of pH as function of current densities for the lithium-air battery with Pt/C as air electrode.

FIG. 11 graphically illustrates XRD patterns of compound LiVS₂ heat treated at 600° C., heat treated at 300° C., heat treated at 200° C., and untreated.

FIG. 12A is an SEM micrograph of unannealed LiVS₂.

FIG. 12B is an SEM micrograph of LiVS₂ annealed at 600° C. for 10 hours.

FIG. 12C is an SEM micrograph of LiVS₂ annealed at 700° C. for 10 hours.

FIG. 13A is an EDS scan micrograph representing the At % of elements for unannealed LiVS₂.

FIG. 13B is an EDS scan micrograph representing the At % of elements for LiVS₂ annealed at 600° C. for 10 hours.

FIG. 13C is an EDS scan micrograph representing the At % of elements for LiVS₂ annealed at 700° C. for 10 hours.

FIG. 14 graphically illustrates charge-discharge voltage plots for unannealed Li_{0.8}VS₂, LiVS₂ annealed at 600° C. for 10 hours, and annealed at 700° C. for 10 hours.

FIG. 15 graphically illustrates discharge and voltage curves for unannealed Li_{0.8}VS₂, LiVS₂ annealed at 600° C. for 10 hours, and annealed at 700° C. for 10 hours.

FIG. 16A graphically illustrates discharge voltage curves for Li_{0.8}VS₂ heated to 600° C.

FIG. 16B graphically illustrates discharge voltage curves for V₂O₅.

FIG. 16C graphically illustrates discharge voltage curves for Li_{0.8}VS₂ heated to 700° C.

FIG. 17A graphically illustrates the cycle life of Li_{0.8}VS₂ heated at 600° C. at the current rate of 0.2 mA/cm.

FIG. 17B graphically illustrates the charge capacity of Li_{0.8}VS₂ heated at 600° C. at the current rate of 0.2 mA/cm.

FIG. 17C graphically illustrates the cycle life of Li_{0.8}VS₂ heated at 600° C. at the current rate of 1 mA/cm.

FIG. 17D graphically illustrates the charge capacity of Li_{0.8}VS₂ heated at 600° C. at the current rate of 1 mA/cm.

FIG. 18 graphically illustrates the charge capacity of Li_{0.8}VS₂ and γ-LiV₂O₅ nanorod at 0.3 mA/cm².

### DESCRIPTION OF PREFERRED EMBODIMENTS

For the purposes of promoting an understanding of the principles of the novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

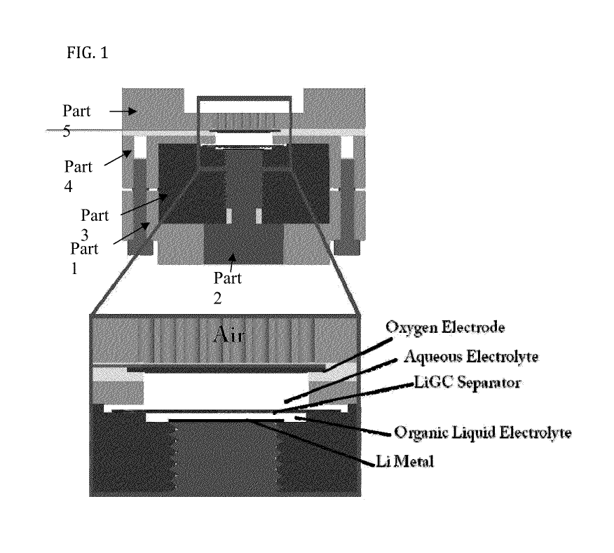

To overcome the challenges faced by Li-air batteries with non-aqueous electrolytes, the present novel aqueous Li-air cell or battery system 10 has been developed (see FIG. 1). The theoretical specific energy densities of Li-air batteries 10 with aqueous electrolytic solutions 20 are around 5000 Whr/kg, which is lower than the theoretical energy densities in non-aqueous solutions (typically around 11249 Whr/Kg). However, a longer cycling life is possible in an aqueous Li-air battery 10 because the discharge products are soluble in aqueous solutions. To protect the Li anode 15 from being exposed to the aqueous electrolytes 20, a Li⁺-conducting Glass Ceramic (LiGC) plate 25 is positioned to separate the anode 15 (typically Li in a non-aqueous electrolyte 35) and the cathode electrode 30 (oxygen reduction reactions in an aqueous solution 20). Typically, the LiGC plate composition is Li_{1.3}Ti_{1.7}Al_{0.3}(PO₄)₃, and typical plate dimensions are about 1 inch×1 inch area, about 150 μm thickness, and σ_{Li}≈10⁻⁴ S/cm.

The novel Li-air batteries 10 typically have the structure of Li electrode 15|organic liquid electrolyte 35|LiGC 25|neutral solution (typically pure DI water, LiClO4 solution or LiNO3 solution) 20|Pt and/or carbon catalytic electrodes 30. To minimize the instability effects of the Li⁺-conducting glass ceramic plate 25 in acidic and alkaline solutions, neutral water is typically used as an electrolyte 20. The novel Li-air battery system 10 enjoys a very high discharge-charge voltage efficiency.

### Example 1

In this Example, the carbon-supported electrocatalyst material for electrode 30, Pt/C (50 wt. % metal on carbon), was purchased commercially and used as received. Vulcan XC-72 electrically conductive carbon black was purchased commercially and used as received. The air catalytic electrode 30 typically includes a catalyst layer 37 and a gas diffusion layer 39. Teflon treated carbon paper was used as the gas diffusion layer 39. Pt/C and XC-72 ink solutions were prepared by mixing Pt/C (80 wt %) or XC-72 (80 wt %), ionomer (G. T. I., 20 wt %) as binder and tetrahydrofuran as solution in an ultrasonic bath for 1 h. The ink solution was then sprayed on one side of the Teflon treated carbon paper 39. The finished air catalytic electrode 30 was soaked into 1M KOH overnight to activate the ionomer and then soaked in deionized (DI) water to remove residual KOH from the surface of the air catalytic electrode 30. The area of the air electrode 30 was 4 cm², and the mass loading of the catalyst layer was 1 mg/cm².

Disks of 0.8 cm in diameter were cut from Li ribbon (0.38 mm thickness) for use as the anode 15. 1M LiPF₆ in EC:DMC (1:1 volume ratio) was used as the electrolyte 35. The LiGC plate 25 had a composition of Li_{1.3}Ti_{1.7}Al_{0.3}(PO₄)₃ and had the dimensions 1 inch×1 inch area, a 150 μm thickness, and a σ_{Li}≈10⁻⁴ S/cm.

The finished battery 10 was exposed to the atmosphere and connected to the testing station. A cell tester was used to perform charge and discharge tests. Electrochemical Impedance Spectroscopy (EIS) experiments were carried out at open circuit voltage. The AC perturbation signal was ±5 mV, and the frequency range was from 1 mHz to 10⁵ Hz.

As shown in FIG. 1, the organic liquid electrolyte 35 was used for the Li-anode 15, while the water aqueous electrolyte 20 was used for air catalytic electrode 30. The anode 45 and cathode 50 were separated by a LiGC plate 25. The Pt-based air catalytic electrode 30, including the catalytic layer and the gas diffusion layer, was placed between the aqueous electrolyte solution 20 and the air atmosphere 40, forming a continuous liquid-solid-gas (three-phase) interface. In the anode 45 the organic liquid electrolyte 35, 1M LiPF6 in EC:DEC, was placed between the Li metal electrode 15 and a solid LiGC electrolyte 55 to provide a solid-liquid-solid interface (Li-organic liquid electrolyte-LIGC). This system alleviated the contact problems between a solid anode and a LiGC plate 25 and, additionally, provided continuous Li-ion mobility between a solid anode 45 and a solid electrolyte 55 during the discharge/charge process. Also, as an alternative to 1M KOH, water 20 was used to minimize chemical instability of the LiGC plate 25 in a strong alkaline aqueous solution, which can affect the electrochemical performances of the battery 10.

The electrode reactions within this Li-air battery 10 can be summarized as follows:

Cathode: O₂+2H₂O+4e⁻→40H⁻ (1)

Anode: Li→Li⁺+e⁻ (2)

Whole reaction: 4Li+O₂+2H₂O→4Li⁺+4OH⁻ (3)

During the discharge, O₂ from air 40 continuously diffuses into the porous catalytic electrode 50, where an electrocatalytic oxygen reduction reaction takes place, according to Eq. (1). Simultaneously, Li metal changes into Li⁺, and Li⁺ diffuses from organic liquid electrolyte 35 to aqueous solution 20 through LiGC plate 25.

The use of neutral solution as electrolyte 20 enables the higher discharge voltages that were observed with the Li-air batteries 10.

According to the Nernst equation:

$$E = {E}^{0} - \frac{RT}{zF} ln \frac{{a}_{Red}}{{a}_{Ox}} \qquad ( 4 )$$

Here, E is the reduction potential at the temperature of interest, E⁰ is the standard reduction potential, R is the universal gas constant (8.314472 J/K·mol), T is the absolute temperature, α is the chemical activity for the relevant species, where α_{Red} is the reductant and αₒₓ is the oxidant (since activity coefficients tend to unify at low concentrations; activities in the Nernst equation are frequently replaced by simple concentrations), F is the Faraday constant (96485.33 C/mol), and z is the number of moles of electrons transferred in the reaction. If a strong alkaline solution is used in Li-air battery 10, the reduction potential of air electrode 30 shifts negatively, according to equations (1) and (4), so that the open circuit voltage, the discharge voltage, and the charge voltage decrease.

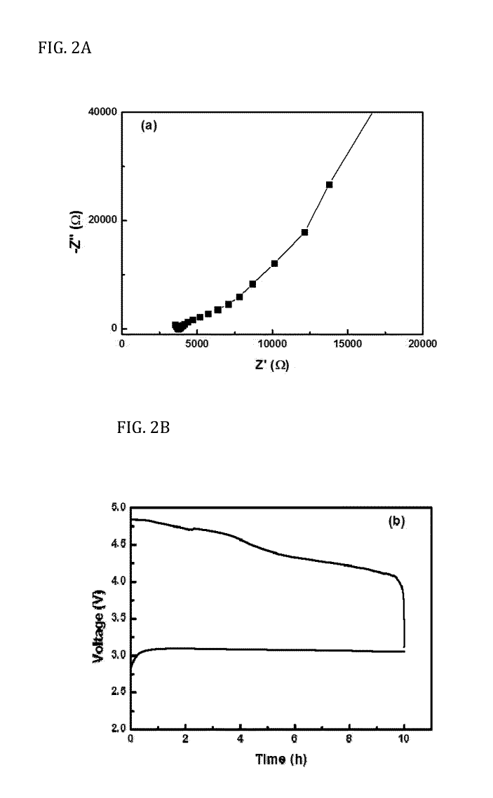

In one embodiment, Li-air battery 10 has a structure of Li 15|organic liquid electrolyte 35|LiGC 25|water 20|carbon air electrode 30, and demonstrates an open circuit voltage (OCV) of about 3.70V. In FIG. 2A, it is illustrated that the internal resistance of Li-air battery 10 decreased from 3393.5Ω (1697 Ωcm²) in pure DI water. As shown in FIG. 2B, the discharge voltage was observed at 3.05V (vs. Li⁺/Li) at the rate of 0.05 mA/cm², 100 mA/g_{carbon}, increased over an Li-air battery 10 embodiment using carbon as catalyst of air electrode 30, while the charge voltage of the battery 10 was in the range of 4.00V to 4.84V (with an average of 4.42V) at the rate of 0.05 mA/cm². The battery 10 was discharged for 10 h and charged up to 5.00V. A high discharge-charge efficiency of 69.0% was observed, which is higher than reported in the literature for Li-air batteries using carbon as catalyst for the air electrode. Table 1 summarizes the reported discharge voltage of Li-air batteries using carbon as catalyst.

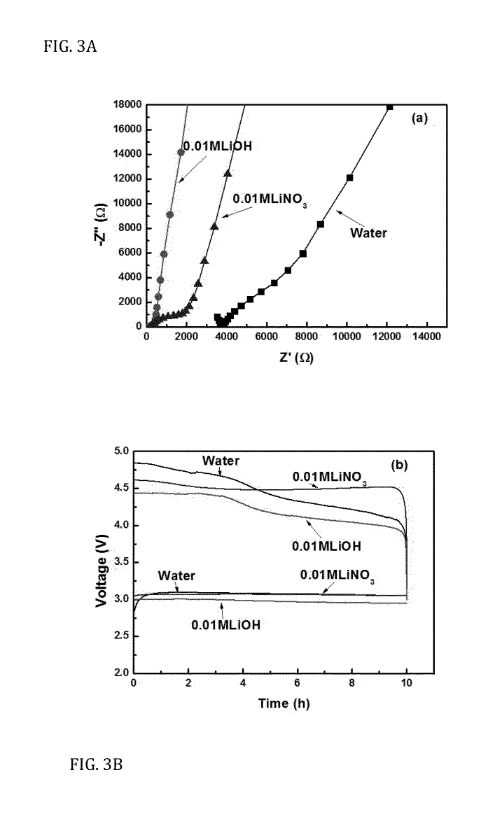

The use of neutral solution (pure DI water) as an electrolyte 20 yields higher discharge voltages from the novel Li-air batteries 10. If a strong alkaline solution is used in a Li-air battery, the reduction potential of the air electrode shifts negatively, according to equations (1) and (4), so that the open circuit voltage, the discharge voltage, and the charge voltage decrease as shown in FIG. 3B. The discharge voltage of the instant Li-air battery 10 decreased from 3.05V in pure DI water to 2.94V in 0.01M LiOH solution at 0.05 mA/cm² or 100 mA/g_{carbon}. According to the Nernst equation (4), the theoretical difference between the reduction voltage in pure DI water and that in the 0.01M LiOH should be 0.15 V. Experimental data showed a difference of 0.11 V between pure water and the 0.01M LiOH solution for the discharge, which is comparable to the theoretical results. Although the performance of the instant novel Li-air battery 10 is much better the prior art batteries, the internal resistance of the novel cell 10 could be lower. Using 0.01M LiOH solution instead of pure DI water reduces the internal resistance as shown in FIG. 3A, and the internal resistance of the novel Li-air battery 10 decreased from 3393.5Ω (1697 Ωcm²) in pure DI water to 127.6Ω (63.8 Ωcm²) in the 0.01M LiOH solution. However, the LiGC plate 25 is not as stable in strong alkaline solution (pH for 0.01M LiOH is 11.45) and the alkaline solution also has a negative effect on the performance of discharge. As this type of LiGC plate 25 is stable in aqueous LiNO₃ and aqueous LiNO₃ is also a neutral solution, LiNO₃ solution was selected to investigate the performance of the Li-air battery 10.

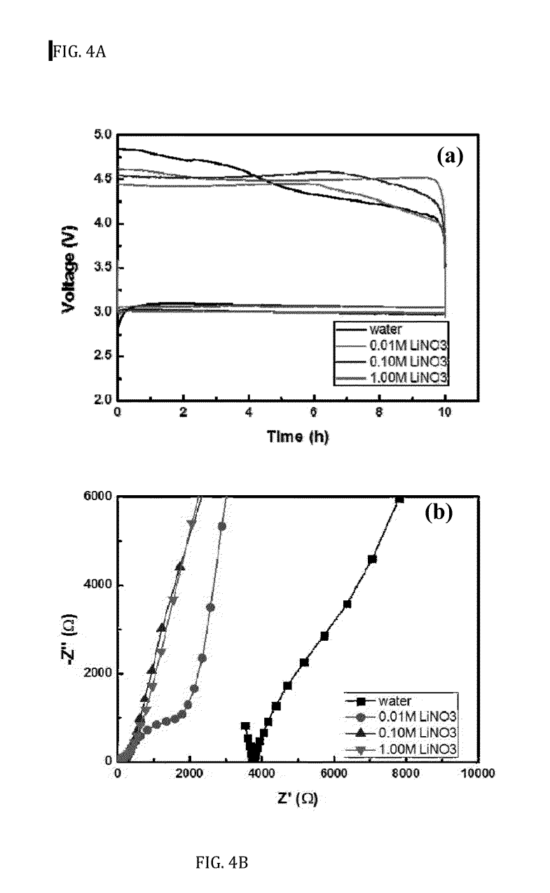

FIG. 4B shows that the internal resistance of the Li-air battery 10 decreased from 3393.5Ω (1697 Ωcm²) in pure DI water to 155.4Ω (77.7 Ωcm²) in the 0.01M LiNO₃ solution, 81.4Ω (40.7 Ωcm²) in the 0.10M LiNO₃ solution and 71.8Ω (35.9 Ωcm²) in the 1.00M LiNO₃ solution. The open circuit voltages of Li-air battery 10 in pure DI water and in the LiNO₃ solution are the same (3.70V), and also in pure DI water and in the 0.01M LiNO₃ solution they have the same discharge voltage at 0.05 mA/cm² or 100 mA/g_{carbon}, 3.05V, as shown in FIG. 4A. With the increased concentration of LiNO₃ solution, the discharge voltage decreased, but in the 0.10M LiNO₃ and in the 1.00 M LiNO₃ solution battery embodiments 10 have the substantially same discharge voltage at 0.05 mA/cm² or 100 mA/g_{carbon} of 2.98V, as shown in FIG. 4A. The charge voltage is an average of 4.42V in pure DI water and an average of 4.50V in the 0.01M LiNO₃ solution, an average of 4.35V in the 0.10M LiNO₃ solution and an average of 4.21V in the 1.00M LiNO₃ solution. Unlike the charge voltage curves observed for batteries 10 using pure water, where a sharp voltage increase was observed at the end of the charge due to the low concentration of Li⁺ in water, the charge voltage remained constant for the battery embodiment 10 using the LiNO₃ electrolyte 20. This stable charge voltage plateau indicates that the charge process can last for an extended period if there is enough Li⁺ in the solution, indicating that a higher charge capacity can be obtained by using a LiNO₃ solution as an electrolyte 20.

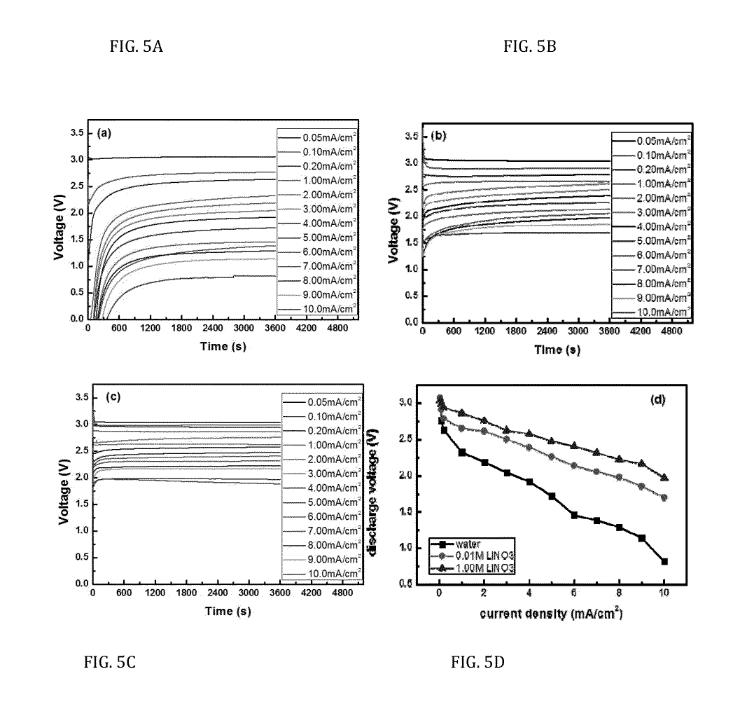

FIG. 5A-C illustrate discharge curves for batteries 10 obtained at different discharge current densities both in water and in LiNO3. The discharge voltage of the novel Li-air battery 10 in pure DI water keeps at 3.05V at a current density of 0.05 mA/cm², and keeps at 0.81V at the current density of 10 mA/cm². The discharge voltage of the novel Li-air battery system 10 in 0.01M LiNO3 keeps at 3.05V at a current density of 0.05 mA/cm², and remains at 1.70V at the current density of 10 mA/cm². The discharge voltage of the novel Li-air battery 10 in 1.00M LiNO3 is much higher than that in pure DI water and in the 0.01M LiNO3 solution. It appears that LiNO3 can improve the performance of the Li-air battery system 10 with carbon as the air electrode 30. With the growth of applied current densities, linear decrease of discharge voltage was clearly observed, as shown in FIG. 5D. It also can be seen that the discharge voltage for Li-air battery 10 in M LiNO3 is much higher than that of Li-air battery 10 in pure DI water.

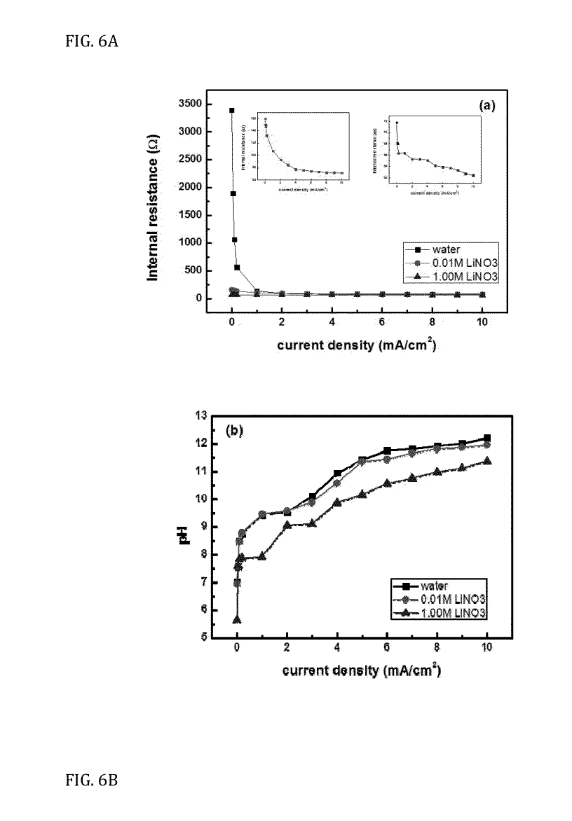

EIS was used to study the changes of the resistances after discharge the battery 10 at certain current densities for 1 hour. FIG. 6A shows the changes of the internal resistances as a function of current density. It can be seen clearly that internal resistances in the novel Li-air battery 10 decrease with increased current densities. The internal resistances decrease rapidly at first and then decrease more slowly as current densities increase beyond about 2.00 mA/cm². The reason for this resistance decrease may be that OH⁻, a product of the oxygen reduction reaction, increases with the increased current densities. The internal resistances for Li-air battery 10 in LiNO3 is much lower than that in pure DI water because there are more Li+ in the water.

To this end, the pH at discharge was measured at predetermined current densities for 1 hour. FIG. 6B plots the changes of pH as a function of current density. It has a similar trend to the changes of the internal resistances as a function of current density. When the current densities are higher than about 2.00 mA/cm², the pH increases to around 12. But pH decreased with increased concentration of LiNO3. This indicates that the LiNO₃ buffers some of basic solution and reduces the increase of pH. The decreased pH can stabilize the LiGC plate 25.

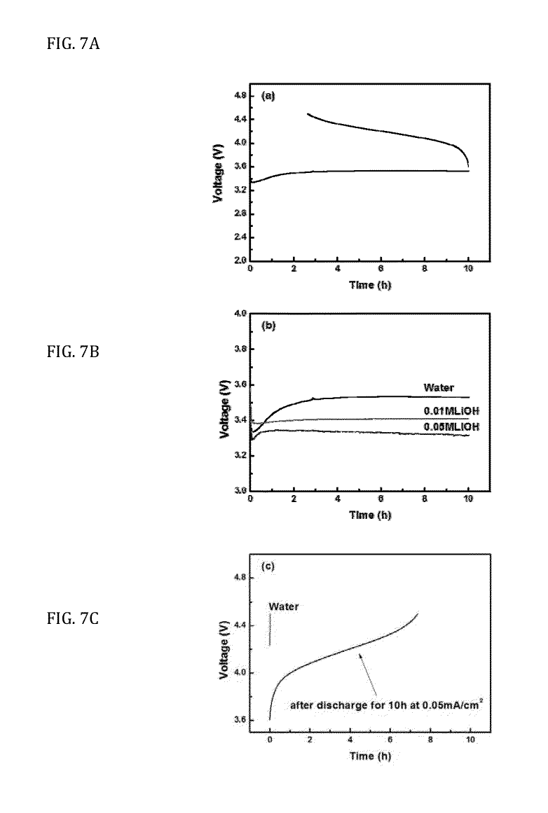

For the novel Li-air battery 10 with a structure of Li 15|organic liquid electrolyte 35|LiGC 25|water 20|Pt air electrode 30, the open circuit voltage (OCV) was about 3.75V. As shown in FIG. 7A, the discharge voltage was observed at 3.53V (vs. Li⁺/Li) at the rate of 0.05 mA/cm², 100 mA/g_{carbon}, while the charge voltage of the battery 10 was in the range of 4.00V to 4.38V (with an average of 4.19V) at the rate of 0.05 mA/cm². The battery 10 was discharged for 10 hour and charged up to 4.50V. The reason for the short discharge time is that the pH of the aqueous electrolyte 20 was found to increase to 7.16, 7.72, and 9.25, respectively, when the battery 10 was discharged for 10 h, 20 h, or 40 hour. Therefore, to minimize the effects on the charge voltage of the decaying LiGC plate 25 in a strong alkaline aqueous solution, the 10 hour discharging time was selected. Surprisingly, a high discharge-charge efficiency of 84% was observed, which is higher than indicated in the prior art.

The novel Li-air battery 10 also shows a higher discharge voltage, while the charge voltage was comparable to others. Table 2 summarizes the reported discharge voltage of Li-air batteries 10 using various catalysts and electrolytes.

As mentioned above, according to equations (1) and (4), the open circuit voltage, the discharge voltage, and the charge voltage decrease with the increased concentrations of LiOH. FIG. 7(B) shows the discharge voltage curve for the Li-air battery 10 in different electrolyte solutions to be 3.53V for pure DI water, 3.40V for the 0.01M LiOH solution, and 3.31V for the 0.05 M LiOH solution. One can see clearly that the discharge voltage decreased with the increased concentrations of LiOH.

Therefore, with the use of pure water as an electrolyte 20 and Pt as a catalytic electrode 30, an 84% discharge-charge efficiency was observed in the novel Li-air battery system 10 that has the structure Li 15|organic liquid electrolyte 35|LiGC 25|water 20|Pt catalytic electrode 30. Eighty-four percent discharge-charge voltage efficiency is significantly higher than the 73% discharge-charge voltage efficiency reported using PtAu/C catalyst, which claimed to have the highest discharge-charge efficiency so far in Li-air battery systems.

It can also be seen in FIG. 7A that the charge voltage increased rapidly as the battery 10 became more fully charged. This indicates that the amount of LiOH formed during the discharge decreases with increasing charge time, which requires higher voltage to convert Li-ion back to Li-metal in a low-concentration alkaline aqueous solution. To confirm that the charge capacity comes solely from LiOH and not from other sources, such as organic or solid electrolytes, an attempt was made to charge the pure DI water without discharging. FIG. 7C shows that the charge voltage of the Li-air battery 10 using pure water increased sharply, compared with the smooth charge curve measured in the solution after discharging at 0.05 mA/cm² for 10 hours.

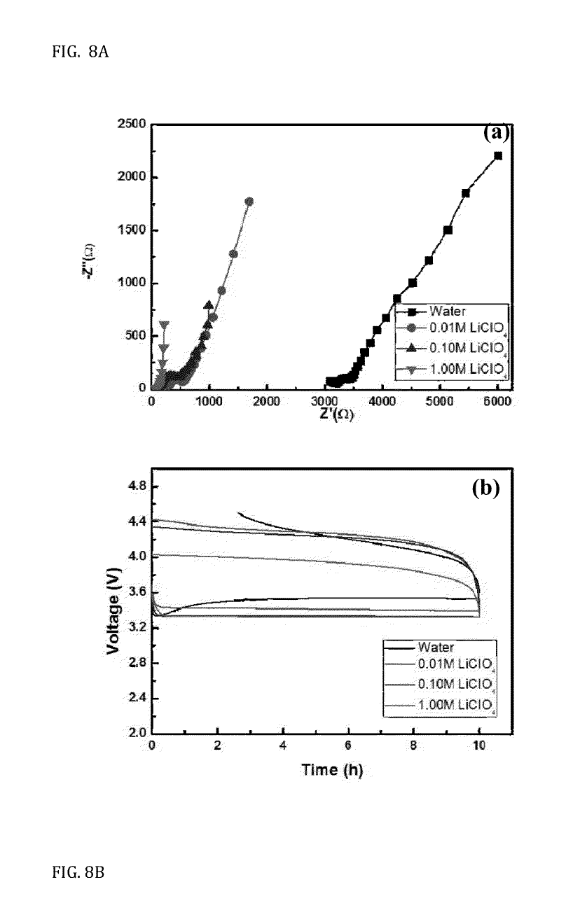

In order to reduce the internal resistance of developed Li-air battery 10 with Pt/C as air electrode 30 and improve the charge performance, the aqueous electrolyte 20 was changed from pure DI water to the LiClO4 to investigate its influence on the electrochemical performance. FIG. 8A shows that the internal resistance of the Li-air battery 10 decreased from 3082Ω (1541 Ωcm²) in pure DI water to 245.4Ω (125.7 Ωcm²) in the 0.01M LiClO4 solution, 82.5Ω (41.3 Ωcm²) in the 0.10M LiClO4 solution, 70.8Ω (35.4 Ωcm²) in the 1.00M LiClO4 solution. The open circuit voltage of the Li-air battery 10 decreased from 3.75V in pure DI water to 3.60V in the LiClO4. The discharge voltage of the novel Li-air battery 10 decreased from 3.53V in pure DI water to 3.39V in 0.01M LiClO4 solution at 0.05 mA/cm² or 100 mA/g_{carbon}, 3.32V in 0.10M LiClO4 solution and 1.00M LiClO4 solution at 0.05 mA/cm² or 100 mA/g_{carbon}, (see FIG. 8(B)). The charge voltage also decreased from an average of 4.19V in pure DI water to an average of 3.90V in the 1.00M LiClO4 solution. The discharge-charge efficiency of the novel Li-air battery 10 in the 1.00M LiClO4 solution is 85%, similar to that of pure DI water.

Unlike the charge voltage curves observed for batteries 10 using pure water, where a sharp voltage increase was observed at the end of the charge due to the low concentration of Li+ and OH⁻ in water, the charge voltage remained constant for the battery 10 using the 1.00M LiClO4 electrolyte. This stable charge voltage plateau indicates that the charge process can last for an extended period if there is enough Li+ and OH− in the solution, indicating that a higher charge capacity can be obtained by using a LiClO4 solution as an electrolyte 20.

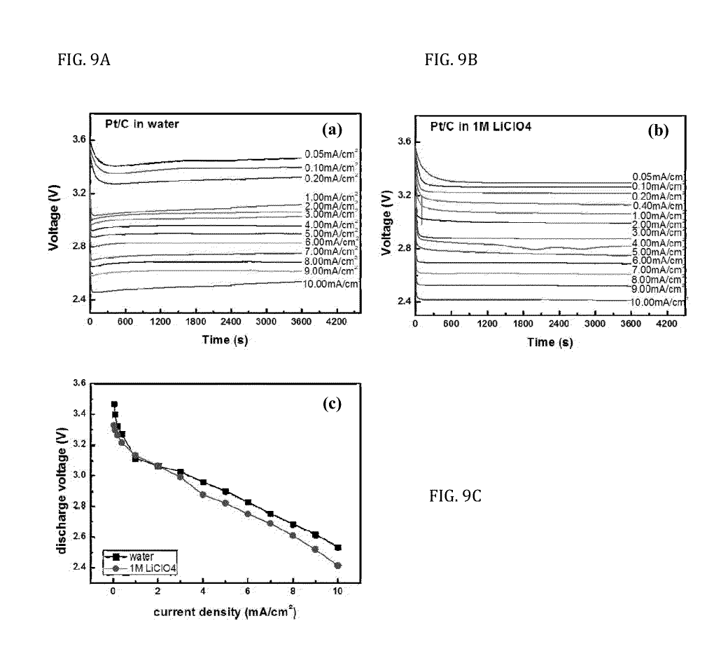

FIGS. 9A and 9B show the discharge curves obtained at different discharge current densities both in water and in LiClO4. The discharge voltage of the novel Li-air battery keeps at 3.53V at a current density of 0.05 mA/cm², whereas it still keeps 2.53V even at the current density of 10 mA/cm². With the growth of applied current densities, linear decrease of discharge voltage is clearly observed, as shown in FIG. 9(C). The discharge voltage of the novel Li-air battery 10 in 1.00M LiNO3 remains at 3.32V at a current density of 0.05 mA/cm², and remains at 2.41V at the current density of 10 mA/cm². The discharge voltage of the novel Li-air battery 10 in 1.00M LiClO4 is a little bit lower than that in pure DI water.

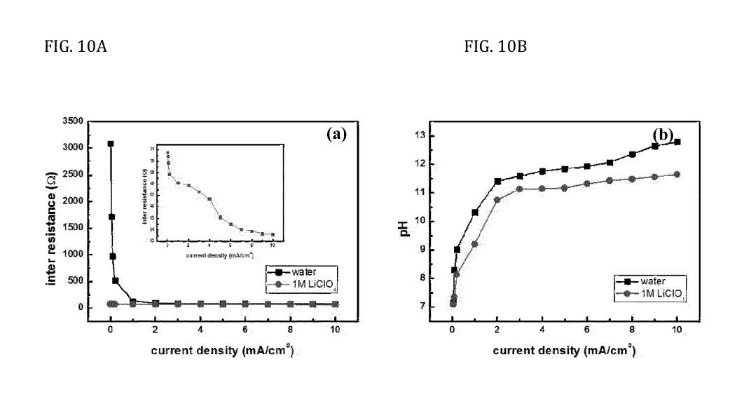

EIS was used to study the changes of the resistances after discharge the battery 10 at certain current densities for 1 hour. FIG. 10A shows the changes of the internal resistances as a function of current density. It can be seen clearly that internal resistances in the novel Li-air battery 10 decrease with the increased current densities. It also can be seen that the internal resistances in LiClO4 is much lower than those in pure DI water. Thus, with the increased current densities the discharge voltage doesn't decrease as rapidly at the beginning of the discharge cycle in LiClO4.

FIG. 10B shows the changes of pH as a function of current density. Current density trends similarly to the changes of the internal resistances as a function of current density. When the current densities are higher than 2.00 mA/cm², the pH increases to around 12, while in LiClO4 solution, the pH decreases. This indicates that the LiClO4 can buffer some of basic solution and then reduced the increased of pH so that it is much better for the LiGC plate.

The performance of a well-designed Li-air battery 10 with a structure of Li 15|organic liquid electrolyte 35|Li⁺-conducting glass ceramic plate 25|water or neutral solution 20|Pt or carbon air electrode 30, using alkaline and acidic solutions as electrolytes, neutral solution was used.

For the Li-air battery with Pt as air electrode, the open circuit voltage observed was around 3.75V. In the water a discharge voltage plateau of around 3.53V (vs. Li⁺/Li) was observed at the discharge current of 0.05 mA/cm² or 100 mA/g_{carbon}. The charge voltage of the Li-air battery 10 was in the range of 4.00V to 4.38V (with an average charge voltage of 4.19V) at a current density of 0.05 mA/cm². The Li-air battery 10 showed the highest discharge-charge voltage efficiency (84% in pure DI water) as compared to efficiencies reported by other researchers. The pH of the liquid electrolyte 20 increased during battery discharge by producing LiOH in the water. In LiClO4 solution, the discharge voltage plateau decreased, but the charge performance improved a lot and the discharge-charge voltage efficiency is 85% in 1M LiClO4. The pH decreased as compared to the changes of pH in water system. For carbon as air electrode 30 in water 20, the discharge voltage was observed at 3.05V (vs. Li⁺/Li) at the rate of 0.05 mA/cm², 100 mA/g_{carbon}, which is higher than what has been reported about Li-air batteries using carbon as catalyst of air electrode, while the charge voltage of the battery 10 was in the range of 4.00V to 4.84V (with an average of 4.42V) at the rate of 0.05 mA/cm². A high discharge-charge efficiency of 69.0% was observed, which is higher than what has been reported for Li-air batteries using carbon as catalyst of air electrode 30. When the LiNO3 solution was used instead of pure DI water, the charge performance improved and also the changes of pH decreased as compared to that in the water.

TABLE 1
summary of the discharge and charge voltage of
Li-air battery using carbon as air electrode.

| | Discharge | Charge | Discharge and |
|---|---|---|---|
| Catalysts | voltage | voltage | charge efficiency |
| Vulcan XC-72 (in | 3.05 V | 4.42 V | 69% |
| water) | | | |
| Vulcan XC-72 (in 0.01M | 3.05 V | 4.50 V | 68% |
| LiNO3) | | | |
| Vulcan XC-72 (in 0.10M | 2.98 V | 4.35 V | 69% |
| LiNO3) | | | |
| Vulcan XC-72 (in 1.00M | 2.98 V | 4.21 V | 71% |
| LiNO3) | | | |
| Super S (MMM)^{[9]} | 2.60 V | 4.80 V | |
| Super P (MMM)^{[5]} | 2.65 V | / | / |
| Ketjen black^{[8]} | 2.60 V | / | / |
| Carbon^{[18]} | 2.60 V | / | / |
| Carbon^{[19]} | 2.50 V | / | / |
| Vulcan XC-72^{[15]} | 2.50 V | 4.50 V | 56% |
| Super P^{[20]} | 2.80 V | / | / |
| Super S (MMM)^{[11]} | 2.60 V | 4.20 V | 62% |
| Carbon^{[6]} | 2.80 V | / | / |
| SWNT^{[21]} | 2.75 V | / | / |
| Carbon^{[22]} | 2.75 V | / | / |
| Carbon^{[23]} | 2.70 V | / | / |

TABLE 2
summary of the discharge voltage depending
on catalysts and electrolytes.

| Catalysts for air | | Discharge |
|---|---|---|
| electrode | Electrolyte | voltage |
| Pt/C | Pure DI water | 3.53 V |
| Pt/C | 0.01MLiOH | 3.40 V |
| Pt/C | 0.05MLiOH | 3.31 V |
| Pt/C | 0.01MLiClO4 | 3.39 V |
| Pt/C | 0.10MLiClO4 | 3.32 V |
| Pt/C | 1.00MLiClO4 | 3.32 V |
| MnOₓ/C^{[16]} | 1M KOH | 3.00 V |
| Carbon^{[5]} | 1M LiBETI DOL:DME (1:1) | 2.65 V |
| Carbon^{[5]} | 1M LiImide DOL:DME(1:1) | 2.65 V |
| Carbon^{[5]} | 1M LiTriflate DOL:DME (1:1) | 2.62 V |
| Carbon^{[5]} | 1M LiBr DOL:DME (1:1) | 2.60 V |
| Carbon^{[5]} | 1M LiBr DOL:DME (1:1) | 2.60 V |
| MnO₂ nanotube^{[10]} | 1M LiPF₆ in propylene carbonate | 2.80 V |
| Co₃O₄^{[9]} | 1M LiPF₆ in propylene carbonate | 2.60 V |
| Carbon^{[15]} | 1M LiClO₄ in PC:DME (1:2 v/v) | 2.50 V |
| Pt/AU_{[15]} | 1M LiClO₄ in PC:DME (1:2 v/v) | 2.70 V |

In another embodiment, the cathode electrode 30 was elected to be LiVS₂, and was prepared by mixing appropriate amount of Li₂S, sulfur, and vanadium in an Ar glove box and portioning the mixture in carbon-coated quartz tubes that were then sealed under vacuum. The tubes were heated slowly over twenty hours to 750° C. and soaked at temperature for three days followed by a slow ramp down over five hours to 250° C., followed by quenching in air. The samples were removed from the tubes in an air glove box where they were thoroughly ground and pelletized. The samples were treated again at the same temperature with the same experimental process. Because these compounds are moisture sensitive, they were handled in an Ar atmosphere.

The LiVS₂ powders were then placed in an Al₂O₃ crucible heated in air. Five specimens of the powders were heated slowly over five hours to reach 200, 300, 500, 600 and 700° C., respectively, and each respective specimen was soaked at temperature for ten hours, followed by ramped cooling six to seven hours to room temperature.

The XRD diffraction data were collected using a diffractometer equipped with Cu-Kα radiation and a diffractometer monochromator that was operated at 45 kV, 30 mA, in step scan mod with a step size of 0.02 degrees and step time 1.5 seconds. The samples were finely ground and placed in the sample holder of the diffractometer. Morphology and the compositional analysis were done by scanning electron microscopy.

The electrode disks 30 and cell 10 were prepared in an Ar glove box. Electrodes 30 were fabricated from a 70:20:10 (wt %) mixture of active material/acetylene black as current conductor and poly(tetrafluoroethylene) as binder. The active material and conductor were mixed completely first, the binder was then added, and the mass mixed again. The mixture was rolled into thin sheets and punched into a 7 mm diameter circular disk as electrodes 30. The typical electrode mass and thickness were 7-12 mg and 0.03-0.08 mm, respectively. The electrochemical cells 10 were prepared in standard 2016 coin cell hardware with Li metal foil used as both the counter and reference electrodes 15. The electrolytes 35 used for analysis were 1M LiPF₆ in 1:1 EC:DEC. The sealed cells 10 were taken out of the glove box and placed in a battery testing system. The cells 10 were aged for five hours before the first discharge (or charge) to ensure full absorption of the electrolyte 35 into the electrode 30. A ten minute rest period was maintained between the charge and discharge steps.

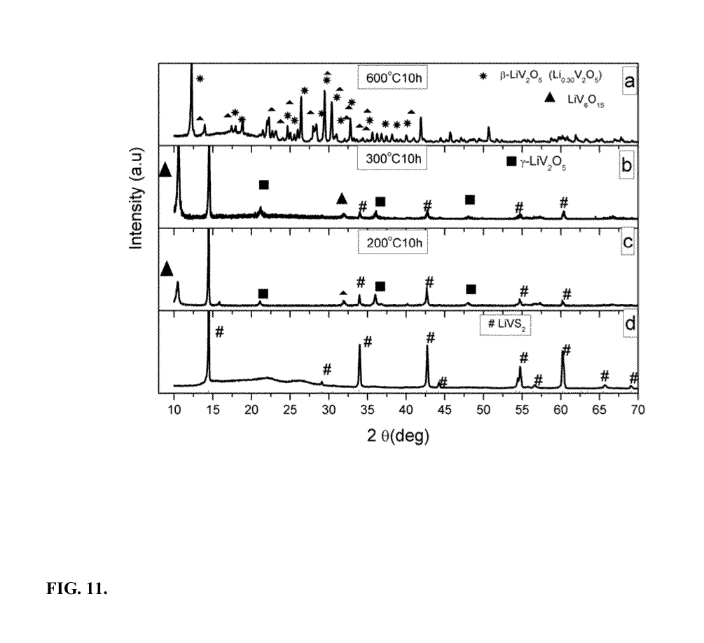

The XRD patterns of the LiVS₂ powder at different temperatures are represented in FIG. 11. It is observed that the LiVS₂ phase is present. The samples were heated at 200, 300, 600 and 700° C. for ten hours under air. The XRD pattern shows that a mixed crystal structure of oxides and sulfides is developed after heating at 200° C. and 300° C. For LiₓV₂O₅ structure, it is well known that at a temperature above 250° C. a phase change from δ-LiₓV₂O₅ (δ→0.9≦x≦1) into γ-LiV₂O₅ (γ→1≦x≦1.9) is observed. For the sample heated at 300° C., the oxides developed at 300° C. are mixed oxides. The XRD peaks correspond to the γ-LiV₂O₅ and a small trace of LiV₆O₁₅ oxides. The XRD patterns of the samples heat treated at 200 and 300° C. indicate that the samples are poorly crystallized, as indicated by lower intensity of the peaks. It is also observed that LiVS₂ phase is still present even at 300° C.

The sample further heated at 600° C. for 10 hours under air yields a well crystallized β-LiV₂O₅ and LiV₆O₁₅ oxide phases. The corresponding XRD pattern shows well defined diffraction lines indexed on the basis of the monoclinic A2/m space group. It is also observed that the small traces of LiVS₂ phase vanished at 600° C. It is observed that with increasing heat treatment temperature the intensity of XRD peaks become stronger and the full width at half maximum (FWHM) parameter decreases, which indicates that the sample became more crystalline. Although the EDS scan of samples annealed at 600° C. shows a small amount (8 At %) of sulfur, the XRD peaks do not show any sulfide phase, which is likely due to an amorphous sulfide phase or that the sulfide has gone into the layer structure of the oxide phases without changing the structure of the oxides phases present in the sample.

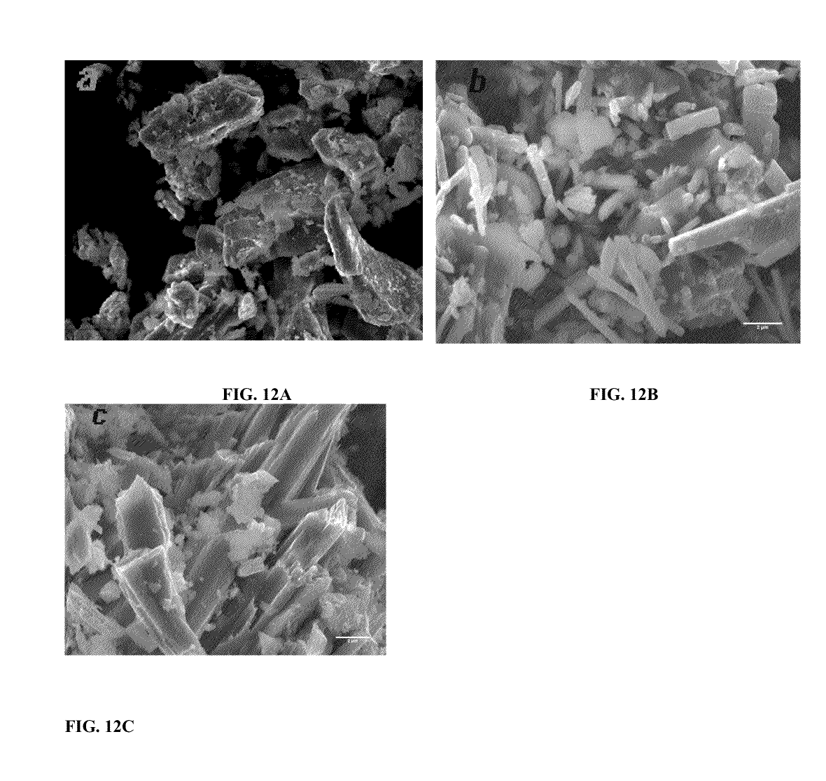

The morphology and the compositional study were done by scanning electron microscopy. The SEM micrographs of the LiVS₂ cathode material 70 samples for different temperatures are shown in FIGS. 12A-12C. It can be seen that heat treatment has changed the crystallinity and morphology of the samples significantly. The sample without heat treatment consists of an agglomeration of samples indicating poor crystallization (FIG. 12A). The sample heated at 600° C. developed well defined micron size elongated dendrite or rod shaped crystallites with widths of 0.3-0.5 μm (FIG. 12B). The well defined rod shapes indicate very good crystallization at high temperature. However, heat treatment at 700° C. shows that the crystal growth occurred and plate-like crystallites were formed. The results are in agreement with the XRD data.

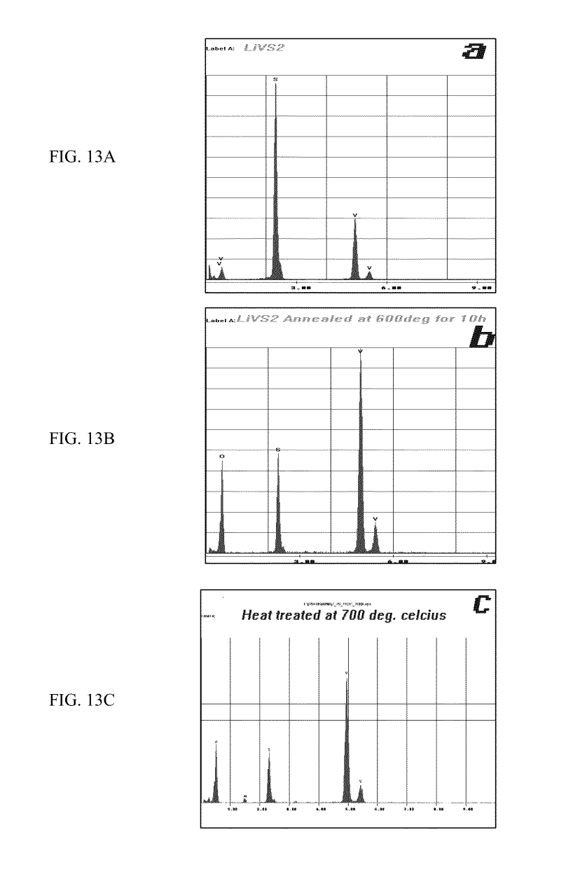

The compositional analysis of the samples annealed at different temperatures was done using the EDS scanning. FIGS. 13A-13D represent the elemental percentile of the samples at respective temperatures. The EDS analysis shows the approximate percentile of elements present in the samples. It is found that the sample LiVS₂ (FIG. 13A) contains approximately 65 At % of S and 34 At % of V. It is notable that Li is not detectable in the EDS analysis, therefore the total atomic % here 100 is assumed for only S and V. On the other hand, LiVS₂ samples annealed at 600° C. contains 68 At % of Oxygen, 24 At % of V and only 7 At % of S (FIG. 13B) and finally FIG. 13C shows the EDS analysis for the sample annealed at 700° C. The At % of S in this sample is 6.47 At % which is less than sample annealed at 600° C. The EDS data reveals that a small amount of sulfide phase is still present in the samples after annealing at 700° C. for 10 hours which is not visible in the XRD patterns.

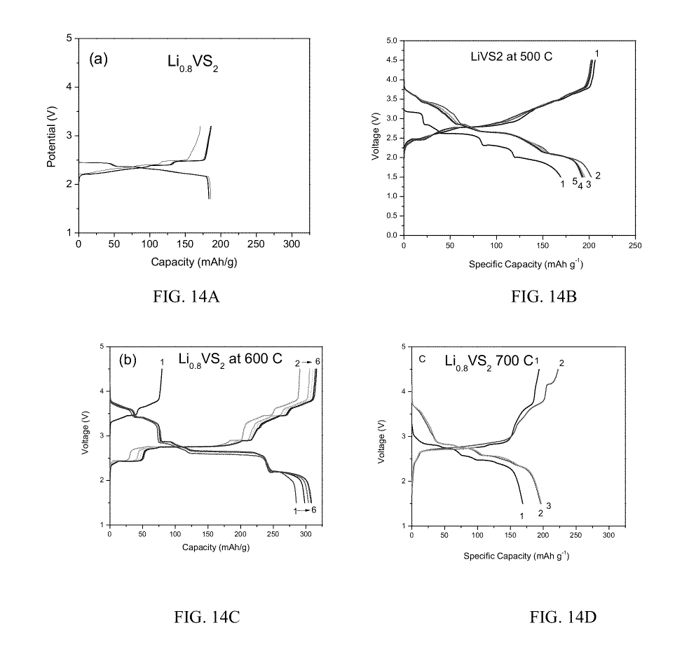

FIGS. 14A-14D show the charge-discharge voltage curves of the pure LiVS₂ sulfide. The voltages corresponding to the charge and discharge appeared to be between 2.5 and 2.1 V. The reversible discharge capacity is approximately 180 mAh/g. When LiVS₂ is heated at 600° C. in air, the values of voltage and capacity were significantly improved. The discharge voltages were between 3.9 and 2.0 V, and quite surprisingly the capacity value reaches up to 300 mAh/g. The capacity value increases during a first few cycles and saturated in the later cycles. However, the samples prepared at 500° C. and 700° C. show a different voltage steps and capacity value from those of the sample prepared at 600° C. At 500° C. and 700° C., the capacity value decreases to 200 mAh/g within the range of 1.6-3.6V. The change in the capacity value could be related to the morphology and crystallinity of the sample.

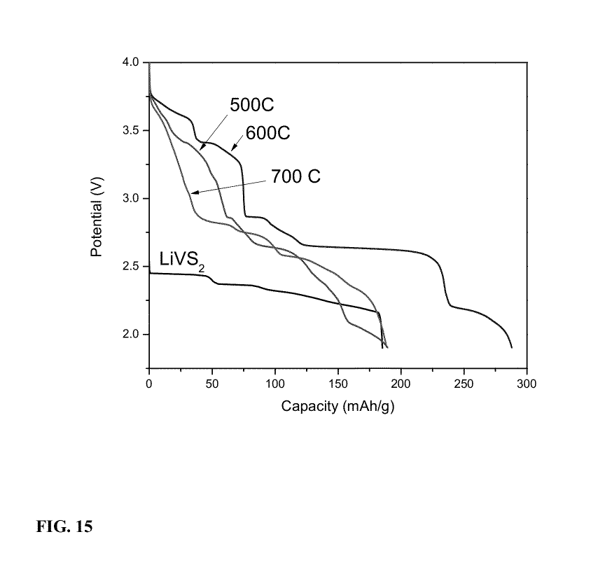

FIG. 15 clearly shows that how voltage and capacity of the discharge depends on the heat treatment of the sample. It is found that the best capacity value was obtained for the sample heat treated at 600° C. The SEM and XRD data shows that at this temperature the sample is perfectly crystalline with a micron size rod shape crystallites which could be the reason for better electrochemical properties, therefore this implies that in this sample the 600° C. temperature is critical optimized electrochemical performances.

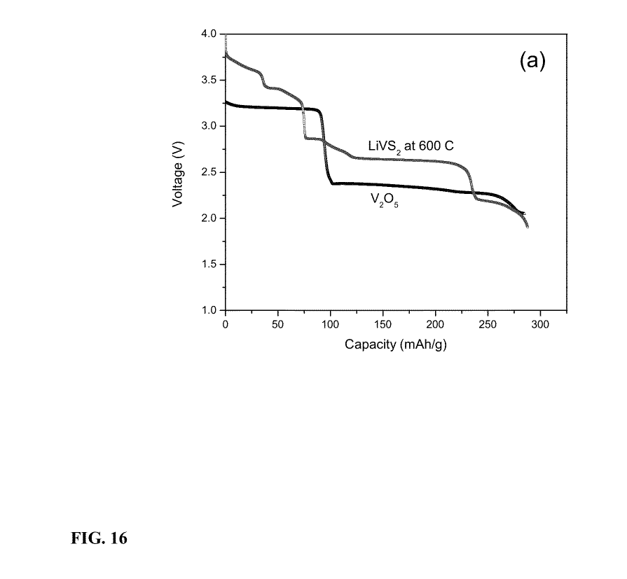

The discharge-charge and voltage curves are well known for β-LiV₂O₅, LiV₆O₁₅ oxides, and LiVS₂ sulfides. However, the discharge-charge and voltage curves for the novel materials are different from the reported oxides and sulfides. In FIG. 16 it is observed that a large capacity up to 300 mAh/g is observed in the novel samples.

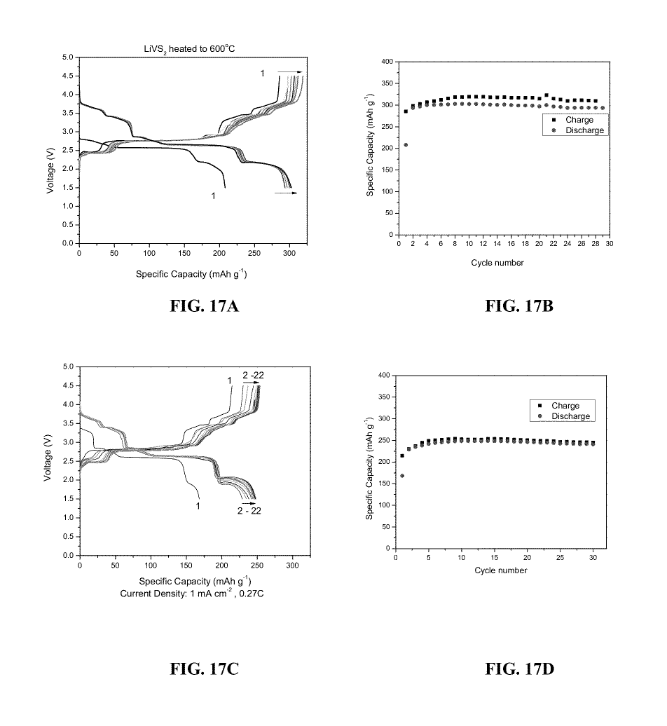

The data generated for the novel samples was compared with that for V₂O₅, as shown in FIG. 16. The voltage steps indicate the phase changes occurred during Li insertion/extraction into/from the structure. The voltage steps observed in the novel samples are quite different from those in V₂O₅ sample. In addition, the novel sample shows an excellent cycle life with keeping the initial capacity, 300 mAh/g as shown in FIGS. 17A-17D.

Therefore, the novel material is different from the reported V₂O₅ compound. It is reported that V₂O₅ structure is complicated and its structure varies with preparation temperature and Li concentration. The XRD results indicate the major peaks match with Li_{0.3}V₂O₅ with some other minor oxides. Sulfide peaks were not observed in the novel material. However, EDS clearly show small amounts of sulfur present in the novel composition. The sulfur observed by EDS could be inside the structure and contributed to form a homogenous oxi-sulfide structure. Alternately, the sulfur could be forming another minor phase and helping to stabilize the major phase to improve the electrochemical performance by improving the electronic conductivity. Small amounts of sulfur ions might have entered the layered structure of V₂O₅ without changing the structure itself while improving the material's capacity. This could be one factor contributing to the voltage curve difference.

The maximum Li numbers that can be reversibly intercalated into LiₓV₂O₅ and Li₁₊ₓV₃O₈ are x=2 and x=3, respectively. So the theoretical capacity for Li₂V₂O₅ and Li₄V₃O₈ is 274 mAh/g and 308 mAh/g. However, the micro-size vanadium oxide samples prepared by normal heat treatment generally give the capacity less than 250 mAh/g with a poor cycle. Hence, to improve their electrochemical performances, many efforts have been don on the fabrication of nano-particles and modification of surface morphologies and chemical composition. Generally, nanosized vanadium oxides provide better capacity, up to ˜300 mAh/g. However, it has been difficult to obtain a stable long cycle-life, which is critical for commercial battery applications.

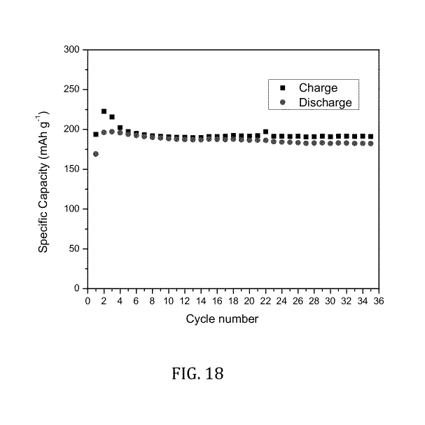

FIGS. 17A-17D show the cycle life of the sample prepared at 600° C. This sample is micro sized crystalline prepared from solid-state reaction by heat treatment. However, the process yields material with a large capacity and good cycle life, exceeding those of nanosized V₂O₅ particles. In addition, even at high current rate, the material exhibits good cycle life with >250 mAh/g. FIG. 18 shows that the samples prepared at 700° C. give an excellent cycle life with 200 mAh/g. Although the capacity of the samples prepared at 500° C. and 700° C. is smaller than that of the sample at 600° C., the specific capacity of over 200 mAh/g is larger than other commercial cathode materials. It is noted that all of the samples in this work are roughly prepared in the University laboratory. In addition, the particle sizes and preparation of electrode are not optimized to maximize the electrochemical properties of the sample. It is believed that the electrochemical performances including capacity, cycle life, and rate capability are expected to be improved when the fabrication conditions are optimized.

It is observed that heat treatment of LiVS₂ sulfide in air is derived to obtain oxy-sulfide compound (or composite) having a structure similar to V₂O₅. The heat treatment produced homogenized rod shape crystallites which are in the few micron size. Also, heat treatment at different temperatures influenced the particle size and morphology of the sample, which consequently influenced their electrochemical properties. The optimal sample was annealed at 600° C. for 10 hr. This indicates that the oxy-sulfide compound (or composite) prepared by heat treatment of sulfides could be a good candidate for cathode materials with a capacity of 300 mAh/g in the range of 2-4 V and better life cycle. This method can apply to other oxide cathode materials.

Other possible oxy-sulfide compounds for electrodes include, but are not limited to, compounds having the general form MₓV_{y}O_{z}Sₖ, where M is Li or Na, and x, y, z, and k may be any reasonable whole number. Likewise, possible oxide/sulfide composites include MₓV_{y}O_{z}/S and/or MₓV_{y}O_{z}/Sulfide, where the Sulfide could be any of combination of M, V, and both, such as MₓS_{y}, VₓS_{y}, or MₓV_{y}S_{z}.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

We claim:

1. A lithium-air electrochemical cell, comprising in combination:
a lithium metal electrode;
a first volume of organic liquid electrolyte in contact with the lithium metal electrode;
a second volume of aqueous liquid electrolyte;
a lithium ion conducting glass ceramic separator positioned between the first and second volumes;
an air electrode in contact with the second volume; and
air in contact with the air electrode.

2. The electrochemical cell of claim 1, wherein the electrodes generate a charge voltage of about 4.2 volts.

3. The electrochemical cell of claim 1, wherein discharge current density is at least about 0.05 mA/cm².

4. The electrochemical cell of claim 1, wherein the aqueous electrolyte is deionized water.

5. The electrochemical cell of claim 1, wherein the aqueous electrolyte is LiClO₄.

6. The electrochemical cell of claim 1, wherein the aqueous electrolyte is LiNO₃.

7. The electrochemical cell of claim 1, and further comprising a discharge/charge voltage efficiency of at least about 75%.

8. The electrochemical cell of claim 1, and further comprising a discharge/charge voltage efficiency of at least about 80%.

9. The electrochemical cell of claim 1, and further comprising a discharge/charge voltage efficiency of at least about 85%.

10. The electrochemical cell of claim 1, wherein the air electrode is carbon.

11. The electrochemical cell of claim 1 and further comprising a solid lithium-ion conducting electrolyte, wherein the organic liquid electrolyte is in contact with the lithium metal electrode and the solid lithium-ion conducting electrolyte.

12. The electrochemical cell of claim 1 wherein the air electrode includes a gas diffusion layer in contact with a catalyst layer.

13. The electrochemical cell of claim 12 wherein the catalyst layer is platinum.

14. An electrochemical cell, comprising:
a first electrode;
a second electrode spaced from the first electrode; and
a lithium ion electrolyte disposed between the first and second electrode and in ionic communication therewith;
wherein the first electrode is selected from the group including LiVS₂, Li_{0.8}VS₂, LiV₂O₅ intercalated with sulfur; LiV₆O₁₅ intercalated with sulfur;
and combinations thereof.

15. The electrochemical cell of claim 14, wherein the second electrode is lithium metal.

16. The electrochemical cell of claim 14, wherein the lithium ion electrolyte is liquid.

17. The electrochemical cell of claim 14 and further comprising:
a first volume of organic liquid electrolyte in contact with the lithium metal electrode;
a second volume of aqueous liquid electrolyte;
a lithium ion conducting glass ceramic separator positioned between the first and second volumes.

18. An electrochemical cell system, comprising:
a lithium metal anode electrode;
a first volume of lithium ion conducting electrolyte in contact with the lithium metal electrode;
a second volume of lithium ion conducting electrolyte in lithium ion communication with the first volume of lithium ion conducting electrolyte;
a cathode electrode in contact with the second volume of lithium ion conducting electrolyte;
wherein the cathode electrode is selected from the group including LiVS₂, Li_{0.8}VS₂, LiV₂O₅ intercalated with sulfur; LiV₆O₁₅ intercalated with sulfur; an air electrode having a gas diffusion layer operationally connected to a catalyst layer; and combinations thereof.

19. The system of claim 18 and further comprising a lithium ion conducting glass ceramic separator positioned between the first and second volumes of lithium ion conducting electrolyte; wherein first volume of lithium ion conducting electrolyte is an organic liquid; and wherein second volume of lithium ion conducting electrolyte is an aqueous liquid.

20. A method of producing a lithium ion battery, comprising:
spacing a lithium metal anode electrode from a cathode electrode to define a battery space therebetween;
placing a first volume of lithium ion conducting electrolyte in contact with the lithium metal electrode;
placing a second volume of lithium ion conducting electrolyte in lithium ion communication with the first volume of lithium ion conducting electrolyte and in contact with the second volume of lithium ion conducting electrolyte;
wherein the cathode electrode is selected from the group including LiVS₂, Li_{0.8}VS₂, LiV₂O₅ intercalated with sulfur; LiV₆O₁₅ intercalated with sulfur; an air electrode having a gas diffusion layer operationally connected to a catalyst layer; and combinations thereof.

21. The system of claim 20 and further comprising:
positioning a lithium ion conducting glass ceramic separator between the first and second volumes of lithium ion conducting electrolyte; wherein first volume of lithium ion conducting electrolyte is an organic liquid; and wherein second volume of lithium ion conducting electrolyte is an aqueous liquid.
